(19) United States
(12) Patent Application Publication
(10) Pub. No.: US 2023/0321769 A1
(43) Pub. Date: Oct. 12, 2023

(54) MICRONIZED FLUX FOR JET VALVE DISPENSER

(71) Applicant: Honeywell International Inc., Charlotte, NC (US)

(72) Inventors: Juergen Rudolph, Peine (DE); Alfred Siggel, Seelze (DE)

(21) Appl. No.: 18/130,025

(22) Filed: Apr. 3, 2023

Related U.S. Application Data
(60) Provisional application No. 63/329,592, filed on Apr. 11, 2022.

(51) Int. Cl. B23K 35/362; B23K 35/02; B23K 35/36; B23K 1/20

(52) U.S. Cl. CPC B23K 35/362; B23K 35/025; B23K 1/203; B23K 35/3613; B23K 35/361

(57) ABSTRACT

A flux paste composition including one or more fluoroaluminate based flux agents, one or more thickening agents, a carrier, a dispersant, a wetting agent, a defoamer, a moderator, and a biocide agent. The flux past composition can be blended with one or more rheological additives selected based upon printing the blended flux composition by a contactless inkjet printing system.

### CROSS REFERENCE TO RELATED APPLICATION

This application claims the benefit under 35 U.S.C § 119(E) of U.S. Provisional Application No. 63/329,592, filed on Apr. 11, 2022, which is incorporated by reference in its entirety.

### FIELD OF THE INVENTION

The present disclosure relates generally to a flux composition that is printable by an inkjet printing system.

### BACKGROUND

Brazing operations, which are used in certain manufacturing operations, such as in heat exchanger manufacturing, have traditionally occurred in vacuum furnaces. More recently, a brazing technique known as “controlled atmosphere brazing (ustCAB)” has become accepted by the automotive industry for making brazed aluminum heat exchangers. Illustrative end uses of CAB brazed aluminum heat exchangers include radiators, condensers, evaporators, heater cores, air charged coolers and intercoolers.

CAB brazing is preferred over vacuum furnace brazing due to improved production yields, lower furnace maintenance requirements, greater braze process robustness and lower capital cost of the equipment employed.

In a CAB process, a fluxing or flux agent is applied to the pre-assembled component surfaces to be jointed. The flux agent is used to dissociate or dissolve and displace the aluminum oxide layer that naturally forms on aluminum alloy surfaces. The flux agent is also used to prevent reformation of the aluminum oxide layer during brazing and to enhance the flow of the brazing alloy. Illustrative flux agents include alkaline metal or alkaline earth metal fluorides or chlorides.

Fluoride-based fluxes are generally preferred for brazing aluminum or aluminum alloys because they are inert or non-corrosive, as are aluminum and its alloys, yet are substantially water insoluble after brazing, and are commonly used by the automotive industry in the manufacture of aluminum and aluminum alloy heat exchangers.

The components of heat exchangers and engine oil coolers made of aluminum traditionally have usually been coated over a large area with a flux paint and brazed. However, only a small proportion of the flux contained in the flux paint is absorbed into the solder and is found as an undesirable residue in the liquid cooling medium after soldering.

More recently, flux paints have been printed in such components. However, the printing of fluxes has proven to be difficult due to the rheology profile and/or physical characteristics of the flux formulations. What is needed is a flux agent composition which provides physical properties that can be adapted to printing systems while maintain brazing performance.

### SUMMARY

The present disclosure provides a flux paste formulation including a fluoride-based flux agent, that when combined with one or more additional additives, forms blended flux composition that is printable by a contactless inkjet printing system. The blended flux composition exhibits high printability while maintaining high brazing performance.

In one embodiment, the present disclosure provides a flux paste composition is provided including one or more fluoroaluminate based flux agents, one or more thickening agents, a carrier, a dispersant, a wetting agent, a defoamer, a moderator, and a biocide agent.

In another embodiment, the present disclosure provides a blended flux composition comprising a micronized flux paste including one or more fluoroaluminate flux agents and one or more rheological additives, the rheological additives selected based upon printing the blended flux composition by a contactless inkjet printing system.

In a further embodiment, the present disclosure provides a method of printing a flux formulation including preparing a flux concentrate including one or more fluoroaluminate flux agents, one or more thickening agents, a carrier, a dispersant, a wetting agent, a defoamer, a moderator, and a biocide agent; micronizing the flux concentrate to form a micronized flux paste; adding one or more rheological additives to the micronized flux paste to form a blended flux formulation; and inkjet printing the blended flux formulation.

### BRIEF DESCRIPTION OF FIGURES

FIG. 1 illustrates embodiments of printed dot lines of the compositions of Examples B, C, D, E, F, G, and K made with a Nordson jet printing head.

FIG. 2 illustrates embodiment of the Nordson jet printing nozzle showing limits for the viscosity of the Jetflux formulation.

FIG. 3 illustrates embodiments of the Nordson jet printing nozzle with splattering and blockage due to incorrect consistency of the printing paste.

FIG. 4 illustrates embodiments of the printed dot structures of the various Jetflux formulations resulting from the performance testing described in the Examples portion of the present disclosure.

### DETAILED DESCRIPTION

### I. Formulations

The present invention relates to a flux composition including, but not limited to, any combination of a micronized blended flux paste including a fluoride-based flux, a shear thinning agent, a low VOC solvent, and a polymeric dispersant. The flux composition can be used in a variety of printing applications, such as inkjet-printing. For example, the flux composition can be used in a contactless, high frequency inkjet printing process where the flux composition is applied in a pattern to join parts of different or similar metals (e.g., aluminum) alloy parts in a brazing process.

Precision application of flux formulations can be accomplished by printing with an inkjet printing type fluid dispensing system. Traditional continuous inkjet (CIJ) printing systems include, among other components, a syringe barrel and a dispensing tip. Traditional CIJ printing tips are relatively small in diameter, such as about 1.0 to 2.0 mm, however, some tip diameters may be greater or less than these amounts. Traditional ink-jet printing type fluid dispensing systems print the fluid in a continuous stream, allowing for the quick and accurate application of flux compositions in a variety of patterns. These types of systems are commonly used through industry, including in tube folding machines.

Contactless inkjet printing, also known as jetting, marks an improvement over traditional CIJ printing systems. One example of contactless ink jet printing is Drop-on-demand (DOD) type inkjet printing. DOD printing technology relates to a contactless ink-jet printing type fluid system that expels fluid from a small diameter jet nozzle one drop at a time. The nozzle diameter of DOD systems may be less than traditional inkjet type fluid dispensing system tips, such as about 0.1-0.8 mm (e.g., as compared to greater than 1 mm in traditional ink-jet printing devices). As such, the maximum particle size of the flux paste components is an important characteristic of DOD applications since DOD printing systems require a smaller particle diameter than that of traditional ink jet tips (e.g., to avoid clogging the DOD fluid dispensing system).

DOD type ink jet systems can print flux formulations by a variety of means including both mechanical and electrical means. In the case of a mechanical means, sound waves or a volumetric expansion can push fluid from the nozzle in individual drops. In the case of an electrical means, a piezoelectric DOD ink-jet printer can be utilized, where when a voltage is applied to a piezoelectric transducer coupled to the print nozzle, the piezoelectric material changes shape and generates a pressure pulse in the fluid which pushes a droplet of fluid from the nozzle. In either of these cases, drops of fluid are contactlessly jetted from the print nozzle (e.g., not requiring any contact between the nozzle and the substrate) at a high frequency, where as much as 8 drops can be expelled to create a agglomerated/combined drop of fluid on the substrate (e.g., providing increased drop size flexibility over traditional approaches). Furthermore, due to the contactless jetting nature of the printing, printing can be accomplished in any variety of horizontal and vertical orientations, such as via a print head mounted on a robotic arm, since the droplet is shot (e.g., jetted) from the print nozzle rather than requiring contact with the substrate as in a traditional CIJ printing system.

Such DOD type fluid dispensing systems enable a large degree of flexibility when printing flux formulations on a variety of constructed parts. Furthermore, DOD systems allow for manufacturers to dispense many types of fluxes at relatively high speeds and with high accuracy. As such, contactless inkjet printing, such as DOD type printing, may reduce the waste generated during the brazing process (e.g., via only dispensing the necessary amount of flux), avoid unnecessary rework and/or rejected product (e.g., via the heightened accuracy of the printing process), and result in higher throughput as compared to other brazing approaches (e.g., as via the quick application capabilities of inkjet printing systems generally, and in particular, DOD type printing systems).

Although the speed of contactless inkjet printing systems has been improving, the increase in speed has led to some drawbacks. High frequency jet valve systems are capable of firing droplets at frequencies at or above 250 Hz. However, high frequency contactless printing systems often require thickening agents to heighten flux paste viscosity. For example, flux formulations for contactless inkjet printing show high viscosities of up to 5000-15.0000 mPas. In this case, Glycol is often used as a thickening additive which, in some instances, can comprise up to 45 wt. % of the flux paste. The high concentration of thickening agents compromises the effectiveness of the paste by creating a lower quality suspension surface (e.g., by containing too much thickening agent vs. flux) which does not dry as readily on the substrate. Furthermore, traditional flux formulations often have broad particle size distributions, which can contain flux particles with large diameters. As a result of these properties, traditional flux formulations for tip dispensing and/or formulations for paints show difficulties when being pumped and passing through fine tubes. As such, these flux formulations may lead to clogging the nozzles of ink jet heads.

Additionally, higher viscosity flux pastes also require higher energy usage when printing. In this case, higher energy and higher frequency jet firing generates excessive heat at the jet valve heads. To counteract this localized buildup of heat, circulating water systems may be used to cool the print heads. As such, although conventional jet printing systems may allow for the accurate application of flux-paste for brazing processes, the drawbacks present significant hurdles to increasing the speed of jet-printing of such formulations.

The present invention relates to an improved flux formulation that can be combined with one or more additional additives to form an overall Jetflux formulation. The Jetflux formulation can be used in a variety of ink-jet type printing applications, including contactless ink-jet printing, and specifically, in DOD type ink-jet printing applications. This Jetflux formulation is relatively high in viscosity at 2000-3000 mPas, allowing for the rapid printing of the flux either by traditional inkjet printing, contactless inkjetting, and/or high frequency contactless ink jetting (e.g., high frequency DOD systems). For example, the preferred viscosity range for Jetflux formulation is between 2000 and 4000 mpas. Higher viscosities may lead to uneven droplet formation and undesirable filament formation at the printhead. Viscosities that are too low lead to droplet formation at the printhead, increased splattering and spray mist formation at the nozzle. The Jetflux formulation may be substantially free from product-compromising thickening agents, such as Glycol. The improved flux formulation may also contain a relatively high percentage of flux agent, enabling the high speed printing of small dots of the flux formulation while achieving high brazing performance. The flux paste is a semi-finished product and may contain 47% flux, of which 96% is a potassium (K) based flux and 4% is a cesium (Cs) based flux. The proportion of Cs flux is further sufficient to braze aluminum alloys containing up to 0.6% magnesium. Since Cs and K flux can be mixed in many ratios, the paste can be adjusted according to the application. Since the Cs flux is costly, the quantity used will likely be smaller than that of the K flux. A flux concentration of 20-40 abs wt. % is sufficient to produce a reliable solder joint. However, since the application quantity in the printing process is relatively small, the flux concentration of the formulation may be much higher than 20-40 abs. wt. %. The viscosity of the semi-finished paste increases sharply with increasing solids content, and as such, a 40-50 wt. % may be preferred for reasons of processability.

The improved flux formulation can include any combination of one or more flux agent(s), a shear thinning agent, a carrier, a dispersant, a wetting agent, a defoamer, a moderator, and/or a biocide agent. In some cases, the flux formulation may be in the form of a paste. As such, hereinafter the improved flux formulation is referred to as the flux paste formulation.

The flux agent(s) of the flux paste formulation may be selected from any number of fluoride-based fluxes suitable for brazing applications. For example, the flux agents may be tetrafluoro aluminate-based flux agents, which can be selected from any suitable tetrafluoro aluminate-based compound. Specifically, the flux agent(s) can be either, or a combination of, potassium aluminum fluoride (KA1F4), aluminum cesium fluoride (AlCsF4), aluminum fluoride (AlF3), caesium fluoride (CsF), rubidium fluoride (RbF), lithium fluoride (LiF), sodium fluoride (NaF), and calcium fluoride (CaF2); potassium fluoroaluminates such as potassium pentafluoroaluminate (K2AlF5, K2AlF5 H2O), and potassium hexafluoroaluminate (K3AlF6). Examples of such fluxes have been described in GB-1438955-A, U.S. Pat. Nos. 4,428,920, 3,951,328, 5,318,764, and 4,579,605. Oxyfluoroaluminum such as Al2F4O and AlFO may also be used. Hydroxyfluoroaluminum such as AlF2(OH), AlF2(OH)—H2O, and AlF(OH)2 may also be used. Fluoroborates such as potassium tetrafluoroborate (KBF4) and sodium tetrafluoroborate (NaBF4) may also be used. Examples of such fluxes have been described in GB-899171-A, GB-1007039-A, and U.S. Pat. No. 4,235,649. Fluorozincates such as potassium trifluorozincate (KZnF3), potassium tetrafluorozincate (K2ZnF4), caesium trifluorozincate (CsZnF3), and caesium tetrafluorozincate (Cs2ZnF4) are also suitable. Examples of such fluxes have been described in DE-199131 11-A and WO-9948641-A. Alkali metal fluorosilicates such as caesium hexafluorosilicate (Cs2SiF6), potassium hexafluorosilicate (K2SiF6), lithium hexafluorosilicate (Si2SiF6), rubidium hexafluorosilicate (Rb2SiF6), sodium hexafluorosilicate (Na2SiF6), and ammonium hexafluorosilicate ((NH4)2SiF6) may be used. Examples of such fluxes have been described in U.S. Pat. No. 5,785,770, DE-19636897-A, U.S. Pat. Nos. 5,985,233, 6,019,856-A, 5,980,650, and WO-98/1 0887-A. Alkali bimetal fluorosilicates such as potassium caesium hexafluorosilicate (KCsSiF6), lithium caesium hexafluorosilicate (LiCsSiF6), rubidium caesium hexafluorosilicate (RbCsSiF6), rubidium potassium hexafluorosilicate (RbKSiF6) and ammonium caesium hexafluorosilicate (NH4CsSiF6) may be used. Alkali metal bifluorosilicates (also referred to as alkali metal hydrofluorosilicates) such as caesium hydrofluorosilicate (CsHSiF6), potassium hydrofluorosilicate (KHSiF6), lithium hydrofluorosilicate (LiHSiF6), and ammonium hydrofluorosilicate (NH4HSiF6) may be used. Caesiumfluoroaluminate complexes such as caesium fluoride (CsF), caesium hexafluoroaluminate (Cs3AlF6), caesium tetrafluoroaluminate (CsAlF4 H2O), and caesium pentafluoroaluminate (CsAlF5, CsAlF5·H2O) are all also suitable. Examples of such fluxes have been described in U.S. Pat. Nos. 4,670,067, 5,171,377, 5,806,752, 5,771,962, and 4,655,385. So called super-fluid fluxes can be used as well.

As described in relation to U.S. patent application Ser. Nos. 16/000,176 and 16/000,178, the disclosure of which are expressly incorporated herein, fluoride-based flux agents and particularly, KAlF4, exhibits advantageous properties when used as a flux agent for brazing processes. In this case, KAlf4 can be used either alone, or in combination with AlCsF4, as the flux agents of the flux paste formulation. For example, in the case where the flux paste formulation contains both the KAlf4 and the AlCsF4 flux agents, the KAlf4 may be the majority flux agent comprising 95% or more of the combined flux agent and the AlCsF4 may be the minority component, comprising less than 5% or less of the combined flux agent. In any of these cases, the flux agent(s) may comprise approximately 40-50 wt. % of the overall flux paste formulation's composition. By mixing KAlF4 and CsAlF4, any melting point between 435° C. and 560° C. can be obtained. In general, the flux or flux mixture melts 20-50° C. below that of soldering components. In the case where the flux melts at a lower temperature (e.g., too early), the flux may evaporate before the solder melts and not develop its effect. In this case, it may be desirable for the flux paste formulation to contain 1-2% cesium flux. This amount of Cesium flux may be sufficient to improve the adhesion of the flux application, to lower the melting temperature by 5-10° C., and/or to braze aluminum alloys containing magnesium. Alternatively, some flux paste formulations (e.g., used for repair pastes) contain 2-6% Cs flux to dissolve thicker oxide layers sufficiently fast. Higher proportions of the cesium-containing flux are used to join aluminum alloys with ZnAl solders at lower temperatures.

The flux paste formulation can also include other components such as thickeners. The specific thickeners utilized may be selected based upon the effect on the physical properties of the flux paste formulation, such as on the overall rheology profile of the flux paste formulation. For example, the thickener may be selected based upon a shear thinning effect that the thickener has on the flux paste formulation's rheology profile such that the overall Jetflux formulation is printable by high-frequency DOD inkjet printing systems. Shear thinning thickeners can be selected from any variety of suitable shear thinning thickeners including cellulose ether-based thickeners (e.g., Hydroxyethyl Cellulose (HCE thickeners)), polysaccharide (PSC) based thickeners, and/or acrylate based thickeners. For example, the shear thinning thickener may be a PSC thickener such as diutan gum, guar, xanthan, cellulose, locust bean, and acacia. Additionally, or alternatively, saccharides including carrageenan, pullulan, konjac, and alginate, sometimes called hydrocolloids, may be used.

The shear thinning thickener may comprise less than 1 wt. % of the overall flux paste formulation's composition. For example, the shear thinning agent may comprises 0.01 wt. % to 0.5 wt. %, 0.01 wt. % to 0.1 wt. %, and/or in a preferred embodiment 0.03 wt. % of the overall flux paste formulation, or any other value encompassed by these ranges. Additionally, or alternatively, an ACH thickener can also be used where used in combination, a more complex and broader rheological profile of the paste is observed.

The flux paste formulation may also include a carrier such as water, glycols, and alcohols. In some cases, solvents with high boiling points and low hazardous risk may be used, for example, propylenglycol, hexylenglycol, propylencarbonate or methylmethoxybutanol. In some embodiments, the carrier may comprise 0 wt. % to 58 wt. %, or more preferably 0 wt. % to 35 wt. % of the flux paste formulation's composition, or any other value encompassed by these ranges.

The flux paste formulation may also include a dispersant. The dispersant may be a polymer (e.g., a polymeric dispersant) which acts to space the individual flux agent particles by means of steric stabilization. For example, the polymeric dispersant may be Disperbyk 190, Zetasperse 1600, acrylates, polyurethanes, polyalkoxylates, fatty acids and phosphoric acids derivates. Dispersing additives lead to a fine-particle and uniform distribution of solid particles in liquid media and ensure the long-term stability of such systems. The additives stabilize pigments (e.g., inorganic, and organic pigments and also inorganic salts) and fillers by steric or ionic effects. Wetting and dispersing additives combine both active principles in one product (i.e., they have a wetting and stabilizing effect at the same time), for example Zetasperse 1600. While standard products suffice for the polar surfaces of inorganic pigments and fillers, polymeric additive solutions are used for high charged fluoroaluminates and their acidic surfaces, in order to achieve a sufficient wetting and stabilization in the system. The dispersant can comprise approximately 0.04 wt. % to 2.0 wt. % of the flux paste formulation's composition, 0.04 wt. % to 0.8 wt. %, 0.08 wt. % to 0.4 wt. %, or any other value encompassed by these ranges.

The flux paste formulation can also include a wetting agent. The wetting agent may also have a rheological effect on the flux paste formulation's composition, such as exhibiting a hydrophobic association with other components of the flux paste formulation, thus competing with the thickening effect at the surface of the dispersed flux particles. This may create a deflocculating effect on the flux paste formulation. Examples of wetting agents can include ZetaSperse® 1600, BASF: Plurafac® LF grades, i.e., Plurafac LF 120, 220, 403, 700, 901, 1430. Lutensol® TO, AO, XL, ON grades; Sasol grades, i.e., Marlox®, Marlipal®; Elementis, i.e., Servoxyl; Allnex: Additol grades; and Julius Hoesch: Berol grades. The wetting agent may comprise between 0.01 wt. %-2 wt. % of the flux paste formulation's composition.

The flux paste formulation can also include a defoaming agent (e.g., a defoamer) such as Surfynol 104 50GP, EVONIK: Surfynol grades, i.e., Surfynol 104, Surfynol DF110, Surfynol AD01; BASF: Degressal, Pluriol, FoamStar®, Foamaster®; BYK: Byk-1711, Byk-011, and Byk-016 silicon-free polymeric defoamer. The defoamer may comprise less than 1 wt. % of the flux paste formulation's composition.

The flux paste formulation can also include a moderating agent (e.g., a moderator). The moderating agent can be selected from any one of, or combination of, a Polyethylene glycol sorbitan monolaurate (TWEEN® 20), a Polyoxyethylenesorbitan monopalmitate (TWEEN® 40), a POE (20) sorbitan monooleate (TWEEN® 80), Ethylenglycols such as EG Ethylenglycol, DEG Diethylenglycol, TEG Trethylenglycol, Propylenglycols such as PG, DPG, TPG, Polypropylenglykol such as PPG 400, PPG 2000, and or other polymers such as PE-PG copolymer, PLA-PEG copolymers, AC-PEG, 4-arm PEG, 8-arm PEG, Hyperbranched PEG Dendrimer. For example, the moderating agent many be Poylethylenglycol PEG 20000. PEG is a suitable moderating agent because it facilitates micronization of the flux crystals as the agent melts during grinding, and forms a lubricant film around the crystals, thus minimizing sliding friction. PEG also suppresses the contact of the highly charged flux crystals in the sedimented state and facilitates the redispersion of the paste after a long storage time. As further examples, the moderating agent may be selected from any one of TWEEN 20, 40, 80, PEG 400, PEG 1000, PEG 10.000, PEG copolymers, 4-arm PEG, 8-arm PEG, Hyperbranched PEG Dendrimers. Addition of a noncharged surfactant, TWEEN, above its critical micelle concentrations (CMCs) suppressed the adhesion between noncoated particles. The extent of this surfactant-induced improvement of the adhesion suppression, however, likely may not exceed the quality of preventing the adhesion that we attained by PEGylating. In any of these cases, the moderator may comprise between 0.1 wt. % to 5 wt. % of the flux paste formulation's composition, 0.1 wt. % to 3 wt. %, 0.5 wt. % to 1 wt. %, or any other value encompassed by these ranges.

The flux paste formulation can also include a biocide agent such as 2-Phenoxyethanol, Thor: Acticide BX-H (BIT), 14, B20; Lanxess: Preventol grades, DP25, DP 18, BIT; BASF: Protectol GA24, GA 25; Clariant: Nipacide BIT 10A; and BASF: Protectol PE. The biocide agent may comprise between 0.01 wt. % to 5 wt. % of the flux paste formulation's composition, 0.01 wt. % to 2 wt. %, 0.1 wt. % to 0.5 wt. %, or any other value encompassed by these ranges.

As described previously, contactless inkjet printing systems may utilize small diameter nozzles (e.g., 0.8-1.0 mm diameters). As such, the flux paste formulations may need to contain particles with diameters either slightly, or substantially, smaller than the diameter of the printing nozzle such that the particles do not clog the nozzle during jetting.

Micronization of the particles is one way of reducing the particle size to an acceptable diameter. Micronization relates to mechanical and/or high shearing operations to downsize the diameters of the particles to the micron (e.g., μm) range diameters. For example, the particles may be micronized to diameters between 100 μm and 1 μm, and preferably between 10 μm and 1 μm, and more preferably 5 μm and 1 μm diameters. Micronization of the particles is determined based upon the measured average particle size distribution (e.g., D5, D50, D95, etc.) of the particles of the flux paste, as determined by laser diffraction based on Mie scattering using the HORIBA LA-920.

Traditional methods of micronization of the particles include mechanical milling (e.g., dry grinding) of the flux paste, sieving out the oversized particles, and re-milling the large particles. Utilization of dry grinding in the subsieve range of 625 mesh (20 microns) to 2,500 mesh (5 microns) proves impractical, and as such, traditional milling processes may be regarded as long, expensive, and inefficient for reducing the size of flux paste formulations for jetting processes.

The formulation begins with the preparation of a flux concentrate (e.g., Jetflux 2805-50Cs) for the production of the micronized flux. In order to obtain a stable dispersion after wet grinding of the flux, a wetting agent, a defoamer, and a dispersant may be added before grinding and the flux mixture in the selected composition. In this step, additives which are stable to grinding and heat are utilized since high shear forces and high temperatures locally on the grinding media occur in the grinding process. For this reason, aqueous dispersions such as those present in the acrylate binder and the various thickeners may be added after the grinding process. Stabilization of the highly filled flux paste is achieved by adding a polymeric dispersant and the polyethylene glycol which can lower the friction of the flux particles.

For the micronization, a FRYMA MS-18 MEDIA MILL 10 HP was used. Annular gap bead mills transfer four times more energy into the product than conventional stirrer mills which improves the particle size but generates some heat. A standard feature of the CoBall®Mill is an efficiency cooling circuit with a large surface area that effectively removes the unwanted heat. However, the high shear forces degrade the rheology control agents and local heat initiate agglomeration of the binder. To avoid these issues, the additives are added to the ground material after grinding and incorporated by means of a dissolver. With a filling ratio of 45-50%, the paste reaches a viscosity of around 11,000 mpas. Although higher filling ratios may be possible, the pumpability of the paste would be reduced and detrimentally interfere with processability.

It has been found that the use of a jet mill can mill flux paste materials to single-digit micron particle sizes (e.g., micronizes the particles) in a single pass, increasing yield and operational efficiencies. In this micronization method, the mill injects high-velocity compressed air into a chamber where a rate-controlled feeder adds the starting raw materials. As the particles enter the airstream, they accelerate and collide with each other and the milling chamber's walls at high velocities. Particle size reduction occurs through a combination of impact and attrition. Impacts arise from the collisions between the rapidly moving particles and between the particles and the wall of the milling chamber. Attrition occurs at particle surfaces as particles move rapidly against each other, resulting in shear forces that can break up the particles.

Beneficially, micronized flux pastes exhibit increased surface area over traditionally milled particles. Milling a material from 30 mesh (595 microns) to 2,500 mesh (5 microns) results in 1,643,000 times the number of particles and a surface area approximately 118 times greater. This allows for faster chemical reaction times and improved melting behavior of the flux paste. As such, the composition of the flux paste formulation may be based upon the ability to mill the flux paste via jet milling.

The stability of the micronized flux paste is an important requirement when being applied via contactless inkjet printing. It is desirable that flocculation, settling, and syneresis do not occur during storage periods. Therefore, the paste may contain as high a ratio of (e.g., high wt. % of) the flux agent as practicable, with a minimal amount of other components. Preferably, the paste should be easy to handle (i.e., capable of flowing or being pumped), and should retain moisture (e.g., not dry out easily).

Accordingly, the base flux paste formulation may be combined with one or more additional additives to form a blended flux formulation (hereinafter, referred to as the Jetflux formulation). The additives may be included in the base flux paste formulation to target advantageous physical properties, including a rheology profile. For example, the addition of wetting and dispersing additives may reduce the viscosity of the flux composition and deflocculate the particles in order to print the Jetflux formulation yet maintain the targeted viscosity at high shear rates during printing. It may also be advantageous to add a polymeric additive, such as a polymeric binder to the flux paste composition. It is preferable that the additive is compatible with the binder that is used in the flux formulation. Therefore, the flux paste formulation may be combined with any combination of additional thickeners, dispersants, and/or carriers to target an advantageous rheology profile of and/or physical property effect on the final Jetflux formulation.

For example, the flux paste formulation may be combined with one or more additional thickeners when forming the Jetflux formulation. One example of an additional thickener includes a polysaccharide (PSC) based thickener, such as a 1% solution of KelcoVIS DG (diutan gum) in water. In some cases, the PSC based thickener may act as a structural thickener and/or as a shear thinning agent. The PSC based thickener may comprise between 1 wt. % and 12 wt. % of the Jetflux formulation's composition, 2 wt. % and 10 wt. %, 3 wt. % and 6 wt. %., or any other value encompassed by these ranges.

Another example of an additional thickener includes an acrylate-based thickener (e.g., an alkali swellable emulsion (ASE)). In some cases, the acrylate-based thickener may act as a structural thickener and be regarded as an organic binder. In these cases, the acrylate thickener/organic binder may be Accusol 820, Arkema Group: Rheosolve™ T633, 635, 637; Ashland: Jaypol™ AT4; Dow Chemical: Acusol™ 820; Lubrizol: Carbopol® EZ, grades; BASF: Aethoxal® TTN, TTA, other grades; and Elementis: RHEOLATE® HX 6008. The acrylate-based thickener/organic binder may comprise between 0 wt. % and 15 wt. % of the Jetflux formulation's composition, 0.5 wt. % and 10 wt. %, 2 wt. % and 6 wt. %, or a value encompassed by these ranges.

Another example of a thickener includes a cellulose ether-based thickener, such as a Hydroxyethyl Cellulose (HEC) thickener or a Hydroxypropyl Cellulose (HPC) thickener. Specifically, the HEC cellulose ether-based thickeners have high solubility in water. Solutions including HEC thickeners are clear, smooth, and visually free from gels. Solutions are non-Newtonian in flow, because they change in viscosity with rate of shear. HPC has solubility in a wide range of polar organic liquids and gives a clear solution at ambient and elevated temperatures. Generally, the more polar the liquid, the better the solution. Methanol and Ethanol, Propylenglycol and Dioxan are suitable organic solvent for all types of HPC. The cellulose ether-based thickener may comprise between 1 wt. % and 12 wt. %, between 2 wt. % and 10 wt. %, or between 3 wt. % and 6 wt. %, or any value encompassed by such ranges, of the Jetflux formulation's composition

A final example of an additional thickener includes an associative thickener, such as a polyurethane (PU) thickener. PU thickeners can be used to increase the viscosity of the Jetflux formulation in the high shear ranges. For example, the PU thickener may be a hydrophobically modified ethoxylated urethane (e.g., HEUR) copolymer such as TegoRheo 8510, Rheobyk 7610, Acusol 880 (DOW), TegoVisco Plus (Evonik), Tafigel PUR (Müinzing), Rheovis PU (BASF), Schwegopur (Schwegmann), Rheobyk-T 1000 VF, T 1010 VF (BYK), and Rheobyk-L 1400 VF. The PU based thickener may comprise between 0.1 wt. % and 10.0 wt. % of the Jetflux formulation's composition, between 0.1 wt. % and 5.0 wt. %, or between 0.5 and 2.0 wt. %, or any value encompassed by such ranges of the Jetflux formulation's composition.

The flux paste formulation may also be combined with one or more dispersants when forming the Jetflux formulation. Dispersing additives lead to a fine-particle and uniform distribution of solid particles in liquid media and provide for long-term stability of such systems. The additives stabilize pigments (inorganic and organic pigments and inorganic salts) and fillers by steric or ionic effects. Wetting and dispersing additives combine both active principles in one product (i.e., they have a wetting and stabilizing effect at the same time) for example Zetasperse 1600. Polymeric additive solutions are used for high charged fluoroaluminates and their acidic surfaces in order to achieve sufficient wetting and stabilization in the system. Commercially, there are different technologies available, such as acrylates, polyurethanes, polyalkoxylates, fatty acids and phosphoric acids derivates. For example, polymeric acrylate-copolymers may be used since such copolymers neutralize surface charge, act by steric stabilization, and are easily thermally degraded. These dispersants may be a polymer (e.g., a polymeric dispersant) which acts to space the individual flux agent particles by means of steric stabilization. The dispersant may specifically be a polymeric dispersants such as Disperbyk 184, Disperbyk 190, DISPERBYK-2015—VOC-free acrylic-copolymer. It is very suitable for aqueous pigment concentrates and it is based on CPT (controlled polymerization technology). This technology enables a close, defined molecular weight distribution that allows an application in many different binder systems. Disperbyk 184: high molecular weight polyurethan dispersant. Additionally or alternatively, Byk: Disperbyk® grades; Bykj et grades, BASF: Dispex Ultra® grades; Evonik: Zetasperse® grades; Newos-gmbh: Newo Tee®; Münzing Chemie: Edaplan® may be used. The polymeric dispersant may comprise between 0.1 wt. % and 5 wt. % of the Jetflux formulation's composition, between 0.1 wt. % and 2 wt. %, between 0.2 and 0.8 wt. %, or any value encompassed by such ranges, of the Jetflux formulation's composition.

The flux paste formulation may also be combined with one or more carriers when forming the Jetflux formulation. The carrier may specifically be water glycols, alcohols and some solvents with high boiling points and low hazardous risks used, for example propylenglycol, hexylenglycol, propylencarbonate or methylmethoxybutanol. The carrier may comprise between 5 wt. % and 70 wt. % of the Jetflux formulation's composition, between 10 wt. % and 30 wt. %, between 15 wt. % and 25 wt. %, or any value encompassed by such ranges of Jetflux formulation's composition.

It has been surprisingly found that the combination of a structural thickener and a PU-thickener are particularly suitable for Jetflux formulations containing a potassium tetrafluoraluminate flux. Without being bound to theory, it is believed that this is due to the comparatively low number of humectants and high amount of flux used in the present flux formulations. As such, the Jetflux formulation comprising a thickener acting as a shear thinning agent selected from one the aforementioned PSC, HCE, and HEUR thickeners has shown to be particularly advantageous.

In each of these cases, the additional additives are frequently added to the flux formulation during the finalization phase, however, these wetting and dispersing additives may be added to the mill base and ground with the flux paste.

### II. Testing of Formulations

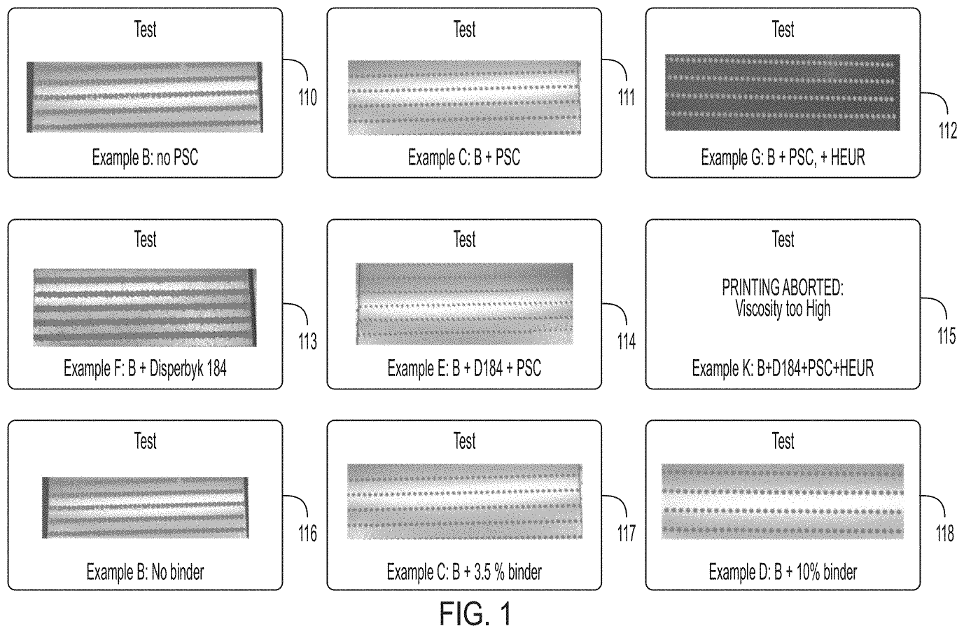

FIGS. 1, 2, 3, and 4 illustrate printing tests performed for a variety of formulations corresponding with a selection of specific formulas described in relation to section III: Examples, below.

It has been found that the printing performance of the flux paste formulations is dependent on the formulation's viscosity, which is influenced by the balance of components in the formulation. The viscosity decreases exponentially by thinning with water. The addition of 20% water may bring the viscosity of the micronized paste into the target range of 2000-4000 mPas. As shown in Table 14 below relating to section III: printing performance of Jetflux paste formulations, the addition of the structure thickener PSC raises the viscosity only slightly, but sustainably reduces the frictional resistance of the flux particles, also prevents settling and, like the PEG, prevents agglomeration of the particles.

In FIG. 1, the printed dot lines immediately show that the Jetflux paste is not smooth without PSC (e.g., tests 110, 113) and the jetter is not able to print clean, sharp dots. With formulations that have a higher PSC content (e.g., test 111), the appearance of filaments is observed. The paste, so formulated, breaks off too late during printing and the drops are no longer round. For this reason, a second associative thickener is added to the paste mixture (e.g., tests 112, 114), which increases the viscosity in the high-shear range and leads to improved shear recovery.

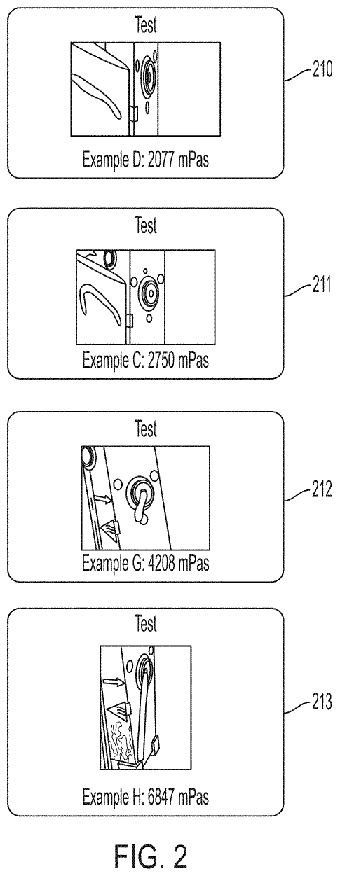

FIG. 2 shows the runner formation at the print nozzle, which clearly demonstrates the limits for the viscosity of the Jetflux formulation. Between 2000 and 3000 mPas it is possible to print without clogging, above 4000 clogging develops. For instance, tests 210 and 212 each illustrate the printing of Jetflux formulations with viscosities below 3000 mPas whereas no clogging is observed, and tests 212 and 213 illustrate Jetflux formulations with viscosities above 4000 mPas whereas clogging is observed.

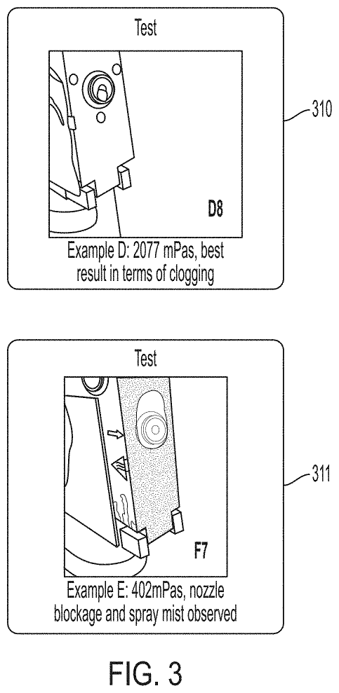

FIG. 3 shows the results of using a printing paste that is too thin. Below 2000 mPas, the printing paste is too thin (e.g., test 311) and spattering and the formation of spray mist are observed. In addition, the added dispersant in Example E increases the particle size and causes blocking of the jetter nozzle.

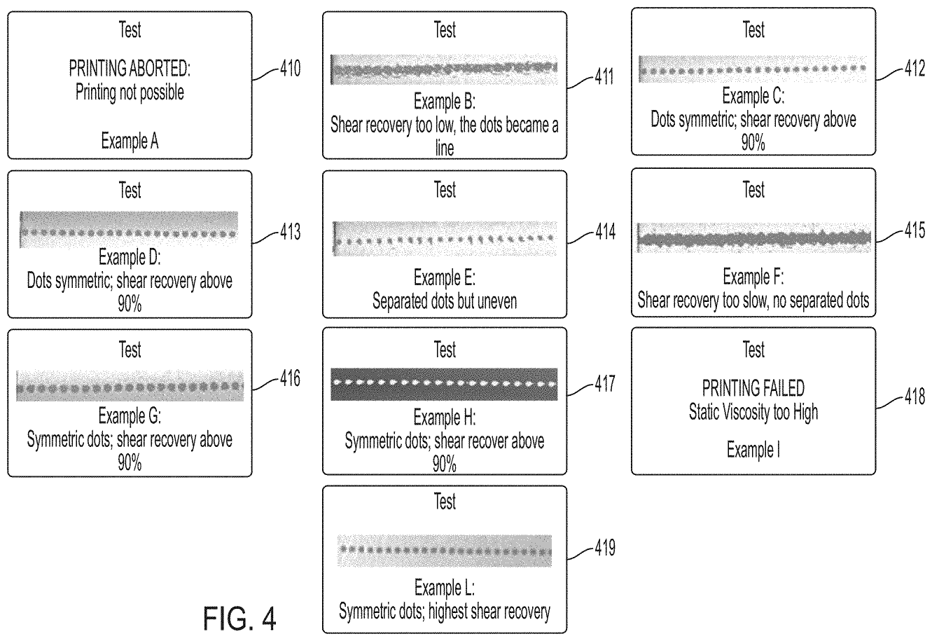

FIG. 4 shows the results of printing the various formulations of the Jetflux Pastes, illustrating the corresponding dot structures revealed during such tests.

### III. Examples

### Preparation of the Flux Paste Formulation:

The following flux paste formulation for jet valve dispensing are provided after a defined production protocol, by firstly combining the micronized flux with a solvent as shown in the tables below, mixed with a normal mixer or high-speed disperser. In a second step, the initially obtained material is combined with a shear thinning agent and other additives. The final flux formulation is homogeneous, stable, and having defined physical and chemical specifications; specifically, the viscosity at 21° C., the solid content, the printability, and the brazing performance. In addition, specific lab controls to check the viscosity reduction when share effect applied is also performed under constant temperature (21° C.) and the particle size defined with laser diffraction/scattering measurements.

TABLE 1
Composition breakdown of micronized flux paste.

| | | | Quantity |
|---|---|---|---|
| Compound | ITE | Part % | [kg] |
| Water | Carrier | 48.65 | 486.50 |
| Disperbyk 190 | Dispersant | 1.75 | 17.50 |
| Zetasperse 1600 | Wetting agent | 1.50 | 15.00 |
| Surfynol 104 50GP | Defoamer | 0.50 | 5.00 |
| Poylethylenglycol | Moderator | 0.25 | 2.50 |
| PEG 20000 | | | |
| 2-Phenoxyethanol | Biocide | 0.20 | 2.00 |
| Diutan gum | Shear thinning | 0.15 | 1.50 |
| | agent | | |
| CsAlF₄ | Cesium flux | 2.00 | 20.00 |
| KAlF₄ | Potassium flux | 45.00 | 450.00 |

### Preparation and Testing of Examples A and B:

In examples A and B, a diluted and micronized flux paste without rheological additives was investigated. The viscosity found is a result of the solids content. Thus, a low viscosity is found at a water content of more than 25%. This paste exhibited good solderability but is not printable. At a solids content above 45%, viscosity increases. In this formulation, viscosity increases exponentially. A paste as in example B with 40% solids tends to clog (i.e., the paste builds up at the outlet of the printer nozzle, and the printed dots are no longer symmetrical.) On a vertical surface, the freshly printed dots start to run.

TABLE 2
Example A - Composition breakdown of micronized paste with 20% solids.

| Compound | Chemical name | ITEM | Part % | Quantity [kg] | solids % | abs w % |
|---|---|---|---|---|---|---|
| Water | | Carrier | 79.66 | 796.60 | | 80.649 |
| Disperbyk 190 | Blockcopolymer | Dispersant | 0.70 | 7.00 | 40% | 0.280 |
| Zetasperse 1600 | 2,4,7,9- | Wetting agent | 0.60 | 6.00 | 15% | 0.090 |
| | Tetramethyldec-5- | | | | | |
| | in-4,7-diol | | | | | |
| Poylethylenglycol | Poylethylenglycol | Moderator | 0.10 | 1.00 | 100% | 0.100 |
| | PEG 20000 | | | | | |
| 2-Phenoxyethanol | 2-Phenoxyethanol | Biocide | 0.08 | 0.80 | 100% | 0.080 |
| Thickener 1 | water-soluble | Shear thinning | 0.06 | 0.60 | 1% | 0.001 |
| | polysaccaride | agent | | | | |
| CsAlF₄ | Cesium tetra | Cesium flux | 0.80 | 8.00 | 100% | 0.800 |
| | fluoroaluminate | | | | | |
| KAlF₄ | Potassium tetra | Potassium flux | 18.00 | 180.00 | 100% | 18.000 |
| | fluoroaluminate | | | | | |
| | | | 100 | 1,000 | | 100 |

TABLE 3
Example B - Composition breakdown of micronized paste with 40% solids.

| Compound | Chemical name | ITEM | Part % | Quantity [kg] | solids % | abs w % |
|---|---|---|---|---|---|---|
| Water | | Carrier | 59.32 | 593.20 | | 61.299 |
| Disperbyk 190 | Blockcopolymer | Dispersant | 1.40 | 14.00 | 40% | 0.560 |
| Zetasperse 1600 | 2,4,7,9- | Wetting agent | 1.20 | 12.00 | 15% | 0.180 |
| | Tetramethyldec- | | | | | |
| | 5-in-4,7-diol | | | | | |
| Poylethylenglycol | Poylethylenglycol | Moderator | 0.20 | 2.00 | 100% | 0.200 |
| | PEG 20000 | | | | | |
| 2-Phenoxyethanol | 2-Phenoxyethanol | Biocide | 0.16 | 1.60 | 100% | 0.160 |
| Thickener 1 | water-soluble | Shear thinning agent | 0.12 | 1.20 | 1% | 0.001 |
| | polysaccaride | | | | | |
| CsAlF₄ | Cesium tetra | Cesium flux | 1.60 | 16.00 | 100% | 1.600 |
| | fluoroaluminate | | | | | |
| KAlF₄ | Potassium tetra | Potassium flux | 36.00 | 360.00 | 100% | 36.000 |
| | fluoroaluminate | | | | | |
| | | | 100 | 1,000.00 | | 100 |

### Preparation and Testing of Example C:

In another example (C), a rheology additive and an acrylate-based organic binder were added to the micronized flux paste from example B, after which a viscosity of below 4000 mPas was measured in this composition and shear recovery increased from 83 to 94%. This has a direct effect on printability and print tests of up to 45,000 dots could be printed without malfunction or interruptions. In addition, the formation of the printed dots was always symmetrical on both horizontal and vertical planes. The flux is almost completely accelerated out of the nozzle in this configuration and no material can be deposited next to the nozzle (clogging).

TABLE 4
Example C - Composition breakdown of micronized paste with rheology additive and organic binder.

| Compound | Chemical name | ITEM | Part % | Quantity [kg] | solids % | abs w % |
|---|---|---|---|---|---|---|
| Water | | | 48.32 | 483.20 | | 60.174 |
| Alberdingk AC3600 | Acrylat- | Binder | 3.50 | 35.00 | 30% | 1.050 |
| | Copolymer- | | | | | |
| | Dispersion | | | | | |
| Thickener 1 | water-soluble | Shear thinning | 7.50 | 75.00 | 1% | 0.075 |
| | polysaccaride | agent | | | | |
| Disperbyk 190 | Blockcopolymer | Dispersant | 1.40 | 14.00 | 40% | 0.560 |
| Zetasperse 1600 | 2,4,7,9- | Wetting agent | 1.20 | 12.00 | 15% | 0.180 |
| | Tetramethyldec-5- | | | | | |
| | in-4,7-diol | | | | | |
| Poylethylenglycol | Poylethylenglycol | Moderator | 0.20 | 2.00 | 100% | 0.200 |
| | PEG 20000 | | | | | |
| 2-Phenoxyethanol | 2-Phenoxyethanol | Biocide | 0.16 | 1.60 | 100% | 0.160 |
| Diutan Gum | water-soluble | Shear thinning | 0.12 | 1.20 | 1% | 0.001 |
| | polysaccaride | agent | | | | |
| CsAlF₄ | Cesium tetra | Cesium flux | 1.60 | 16.00 | 100% | 1.600 |
| | fluoroaluminate | | | | | |
| KAlF₄ | Potassium tetra | Potassium flux | 36.00 | 360.00 | 100% | 36.000 |
| | fluoroaluminate | | | | | |
| | | | 100 | 1,000 | | 100 |

### Preparation and Testing of Example D:

A tripling of the organic binder in the flux formulation leads to a further reduction of the viscosity from 3400 to 2000 mPas. The printability remains high, but the high hydrocarbon content leads to increased carbon black formation in the brazing angle test. The combustion of the organic ingredients is no longer complete and black carbon precipitates on the solder seam, which is not tolerated by users. In order to lower the viscosity of a highly filled paste, another formulation is required.

TABLE 5
Example D - Composition breakdown of micronized paste with tripled concentration of organic binder.

| Compound | Chemical name | ITEM | Part % | Quantity [kg] | solids % | abs w % |
|---|---|---|---|---|---|---|
| Water | | | 41.3 | 413.20 | | 57.95 |
| Alberdingk | Acrylat-Copolymer- | Binder | 10.5 | 105.00 | 30% | 3.150 |
| AC3600 | Dispersion | | | | | |
| Thickener 1 | water-soluble | Shear thinning agent | 7.50 | 75.00 | 1% | 0.075 |
| | polysaccaride | | | | | |
| Disperbyk 190 | Blockcopolymer | Dispersant | 1.40 | 14.00 | 40% | 0.560 |
| Zetasperse 1600 | 2,4,7,9- | Wetting agent | 1.20 | 12.00 | 15% | 0.180 |
| | Tetramethyldec-5- | | | | | |
| | in-4,7-diol | | | | | |
| Poylethylenglycol | Poylethylenglycol | Moderator | 0.20 | 2.00 | 100% | 0.200 |
| | PEG 20000 | | | | | |
| 2-Phenoxyethanol | 2-Phenoxyethanol | Biocide | 0.16 | 1.60 | 100% | 0.160 |
| Diutan Gum | water-soluble | Shear thinning agent | 0.12 | 1.20 | 1% | 0.12 |
| | polysaccaride | | | | | |
| CsAlF₄ | Cesium tetra | Cesium flux | 1.60 | 16.00 | 100% | 1.600 |
| | fluoroaluminate | | | | | |
| KAlF₄ | Potassium tetra | Potassium flux | 36.0 | 360.0 | 100% | 36.00 |
| | fluoroaluminate | | | | | |
| | | | 100 | 1,000. | | 100. |

### Preparation and Testing of Example E:

TABLE 6
Example E - Composition breakdown of micronized paste with binder, thickener and dispersant D184.

| Compound | Chemical name | ITEM | Part % | Quantity [kg] | solids % | abs w % |
|---|---|---|---|---|---|---|
| Water | | | 40.82 | 408.20 | | −60.995 |
| Disperbyk 184 | Block copolymer 2 | Polymeric dispersant | 4.00 | 40.00 | 30% | 120.000 |
| Alberdingk | Acrylat-Copolymer- | Binder | 7.00 | 70.00 | 30% | 2.100 |
| AC3600 | Dispersion | | | | | |
| Thickener 1 | water-soluble | Shear thinning agent | 7.50 | 75.00 | 1% | 0.075 |
| | polysaccaride | | | | | |
| Disperbyk 190 | Blockcopolymer | Dispersant | 1.40 | 14.00 | 40% | 0.560 |
| Zetasperse 1600 | 2,4,7,9- | Wetting agent | 1.20 | 12.00 | 15% | 0.180 |
| | Tetramethyldec-5- | | | | | |
| | in-4,7-diol | | | | | |
| Poylethylenglycol | Poylethylenglycol | Moderator | 0.20 | 2.00 | 100% | 0.200 |
| | PEG 20000 | | | | | |
| 2-Phenoxyethanol | 2-Phenoxyethanol | Biocide | 0.16 | 1.60 | 100% | 0.160 |
| Diutan gum | water-soluble | Shear thinning agent | 0.12 | 1.20 | 100% | 0.120 |
| | polysaccaride | | | | | |
| CsAlF₄ | Cesium tetra | Cesium flux | 1.60 | 16.00 | 100% | 1.600 |
| | fluoroaluminate | | | | | |
| KAlF₄ | Potassium tetra | Potassium flux | 36.00 | 360.00 | 100% | 36.000 |
| | fluoroaluminate | | | | | |
| | | | 100 | 1.000.00 | | 10 |

### Preparation and Testing of Example F:

As the next example-F illustrates, the addition of a dispersant effectively reduces the viscosity of the flux paste from just under 3000 mPas to 400 mPas. Solderability is excellent and virtually no carbon black residue is found on the solder seam. The printability is given, but dropouts are observed in the continuous pressure test which indicate that the nozzle should be cleaned. This becomes understandable when looking at the particle size of the flux mixture after adding this dispersant. Without addition, the D50 value was measured in the range of 1-5 μm, preferably 3 μm. After addition of the dispersant, the D50 increases to over 90 μm and 95% of the particles are larger than 200 μm. This means that the particles are already as large as the effective width of the jetter nozzle, which usually has a diameter of 200-300 μm. When using this flux paste in jet printing, the jetter is frequently clogged by particles that are too large or by agglomerates of the flux powder.

TABLE 7
Example F - Composition breakdown of micronized paste with dispersant.

| Compound | Chemical name | ITEM | Part % | Quantity [kg] | solids % | abs w % |
|---|---|---|---|---|---|---|
| Water | | | 55.32 | 553.20 | | 59.98 |
| Disperbyk 184 | Block copolymer 2 | Polymeric dispersant | 4.00 | 40.00 | 30% | 1.200 |
| Disperbyk 190 | Blockcopolymer | Dispersant | 1.40 | 14.00 | 40% | 0.560 |
| Zetasperse 1600 | 2,4,7,9- | Wetting agent | 1.20 | 12.00 | 15% | 0.180 |
| | Tetramethyldec-5- | | | | | |
| | in-4,7-diol | | | | | |
| Poylethylenglycol | Poylethylenglycol | Moderator | 0.20 | 2.00 | 100% | 0.200 |
| | PEG 20000 | | | | | |
| 2-Phenoxyethanol | 2-Phenoxyethanol | Biocide | 0.16 | 1.60 | 100% | 0.160 |
| Diutan Gum | water-soluble | Shear thinning agent | 0.12 | 1.20 | 1% | 0.12 |
| | polysaccaride | | | | | |
| CsAlF₄ | Cesium tetra | Cesium flux | 1.60 | 16.00 | 100% | 1.600 |
| | fluoroaluminate | | | | | |
| KAlF₄ | Potassium tetra | Potassium flux | 36.00 | 360.00 | 100% | 36.000 |
| | fluoroaluminate | | | | | |
| | | | 100 | 1,000 | | 100 |

The testing of Example F reveals two issues. Firstly, if the viscosity is too low, the paste is not storage stable because the flux sediments and the solid phase separates during transport or application. In addition, the printed dots are again asymmetrical and run into each other. Sedimentation is prevented by the use of a structure thickener, as already described. However, to prevent the dots from running into each other, it is better to use a second associative thickener, which gives the paste a certain restoring force. This restoring force can be measured as shear recovery and is calculated from the ratio of the viscosity measured under high shear to the resting state.

### Preparation and Testing of Example G:

Example-G illustrates the use of an associative thickener, again together with the Jetflux paste. The viscosity of the Jetflux paste at 80% dilution is increased from 2750 to 4200 mPas. At the same time, the Scheer recovery increases from 85 to 100%. The particle size is not adversely changed and the D95 remains below 10 μm. Printability is given and the formation of the printed dots is symmetrical in vertical and horizontal orientation.

TABLE 8
Example G - Composition breakdown of micronized paste with associative thickener.

| Compound | Chemical name | ITEM | Part % | Quantity [kg] | solids % | abs w % |
|---|---|---|---|---|---|---|
| Water | | | 56.82 | 568.20 | | 59.799 |
| TegoRheo8510 | Polyurethane | Shear thinning agent | 2.50 | 25.00 | 60% | 1.500 |
| Disperbyk 190 | Blockcopolymer | Dispersant | 1.40 | 14.00 | 40% | 0.560 |
| Zetasperse 1600 | 2,4,7,9-Tetramethyldec-5- | Wetting agent | 1.20 | 12.00 | 15% | 0.180 |
| | in-4,7-diol | | | | | |
| Poylethylenglycol | Poylethylenglycol PEG | Moderator | 0.20 | 2.00 | 100% | 0.200 |
| | 20000 | | | | | |
| 2-Phenoxyethanol | 2-Phenoxyethanol | Biocide | 0.16 | 1.60 | 100% | 0.160 |
| Diutan Gum | water-soluble polysaccaride | Shear thinning agent | 0.12 | 1.20 | 100% | 0.12 |
| CsAlF₄ | Cesium tetra | Cesium flux | 1.60 | 16.00 | 100% | 1.600 |
| | fluoroaluminate | | | | | |
| KAlF₄ | Potassium tetra | Potassium flux | 36.00 | 360.00 | 100% | 36.000 |
| | fluoroaluminate | | | | | |
| | | | 100 | 1,000 | | 100 |

### Preparation and Testing of Examples H and I:

Examples H and I include increased the associative thickener concentration, which has a positive effect on Scheer recovery, but the accompanying increase in viscosity leads to very severe clogging and a decrease in the maximum printed number of flux dots.

TABLE 9
Example H - Composition breakdown of micronized paste with associative thickener.

| Compound | Chemical name | ITEM | Part % | Quantity [kg] | solids % | abs w % |
|---|---|---|---|---|---|---|
| Water | | | 54.32 | 543.20 | | 58.18 |
| TegoRheo8510 | Polyurethane | Shear thinning | 5.00 | 50.00 | 60% | 3.000 |
| | | agent | | | | |
| Disperbyk 190 | Blockcopolymer | Dispersant | 1.40 | 14.00 | 40% | 0.560 |
| Zetasperse | 2,4,7,9-Tetramethyldec-5- | Wetting agent | 1.20 | 12.00 | 15% | 0.180 |
| 1600 | in-4,7-diol | | | | | |
| Poylethylenglycol | Poylethylenglycol PEG | Moderator | 0.20 | 2.00 | 100% | 0.200 |
| | 20000 | | | | | |
| 2-Phenoxyethanol | 2-Phenoxyethanol | Biocide | 0.16 | 1.60 | 100% | 0.160 |
| Diutan Gum | water-soluble polysaccaride | Shear thinning | 0.12 | 1.20 | 100% | 0.12 |
| | | agent | | | | |
| CsAlF₄ | Cesium tetra | Cesium flux | 1.60 | 16.00 | 100% | 1.600 |
| | fluoroaluminate | | | | | |
| KAlF₄ | Potassium tetra | Potassium flux | 36.00 | 360.00 | 100% | 36.000 |
| | fluoroaluminate | | | | | |
| | | | 100.00 | 1,000.00 | | 100.00 |

TABLE 10
Example I - Composition breakdown of micronized paste with associative thickener.

| Compound | Chemical name | ITEM | Part % | Quantity [kg] | solids % | abs w % |
|---|---|---|---|---|---|---|
| Water | | | 51.82 | 518.20 | | 56.68 |
| TegoRheo8510 | Polyurethane | Shear thinning agent | 7.50 | 75.00 | 60% | 4.500 |
| Disperbyk 190 | Blockcopolymer | Dispersant | 1.40 | 14.00 | 40% | 0.560 |
| Zetasperse 1600 | 2,4,7,9- | Wetting agent | 1.20 | 12.00 | 15% | 0.180 |
| | Tetramethyldec-5-in- | | | | | |
| | 4,7-diol | | | | | |
| Poylethylenglycol | Poylethylenglycol | Moderator | 0.20 | 2.00 | 100% | 0.200 |
| | PEG 20000 | | | | | |
| 2-Phenoxyethanol | 2-Phenoxyethanol | Biocide | 0.16 | 1.60 | 10% | 0.16 |
| Diutan Gum | water-soluble | Shear thinning agent | 0.12 | 1.20 | 100% | 0.12 |
| | polysaccaride | | | | | |
| CsAlF₄ | Cesium tetra | Cesium flux | 1.60 | 16.00 | 100% | 1.600 |
| | fluoroaluminate | | | | | |
| KAlF₄ | Potassium tetra | Potassium flux | 36.00 | 360.00 | 100% | 36.000 |
| | fluoroaluminate | | | | | |
| | | | 100. | 1,000.00 | | 100.0 |

### Preparation and Testing of Example J

TABLE 11
Example J - Composition breakdown of micronized paste with associative thickener.

| Compound | Chemical name | ITEM | Part % | Quantity [kg] | solids % | abs w % |
|---|---|---|---|---|---|---|
| Water | | | 42.52 | 425.20 | | 57.08 |
| Alberdingk | Acrylat-Copolymer- | Binder | 7.00 | 70.00 | 40% | 2.800 |
| AC3600 | Dispersion | | | | | |
| Thickener 1 | water-soluble | Shear thinning agent | 7.30 | 73.00 | 1% | 0.073 |
| | polysaccaride | | | | | |
| TegoRheo8510 | Polyurethane | Shear thinning agent | 2.50 | 25.00 | 60% | 1.500 |
| Disperbyk 190 | Blockcopolymer | Dispersant | 1.40 | 14.00 | 40% | 0.560 |
| Zetasperse 1600 | 2,4,7,9-Tetramethyldec- | Wetting agent | 1.20 | 12.00 | 15% | 0.180 |
| | 5-in-4,7-diol | | | | | |
| Poylethylenglycol | Poylethylenglycol PEG | Moderator | 0.20 | 2.00 | 100% | 0.200 |
| | 20000 | | | | | |
| 2-Phenoxyethanol | 2-Phenoxyethanol | Biocide | 0.16 | 1.60 | 0% | — |
| Thickener 1 | water-soluble | Shear thinning agent | 0.12 | 1.20 | 1% | 0.001 |
| | polysaccaride | | | | | |
| CsAlF₄ | Cesium tetra | Cesium flux | 1.60 | 16.00 | 100% | 16.00 |
| | fluoroaluminate | | | | | |
| KAlF₄ | Potassium tetra | Potassium flux | 36.00 | 360.00 | 100% | 36.000 |
| | fluoroaluminate | | | | | |
| | | | 100.00 | 1,000.00 | | 100.00 |

### Preparation and Testing of Example K

TABLE 12
Example K - Composition breakdown of micronized paste with associative thickener.

| Compound | Chemical name | ITEM | Part % | Quantity [kg] | solids % | abs w % |
|---|---|---|---|---|---|---|
| Water | | | 42.02 | 420.20 | | −149.51 |
| Disperbyk 184 | Block copolymer 2 | Polymeric dispersant | 4.00 | 40.00 | 52% | 208.00 |
| Alberdingk | Acrylat-Copolymer- | Binder | 3.50 | 35.00 | 40% | 1.400 |
| AC3600 | Dispersion | | | | | |
| Thickener 1 | water-soluble | Shear thinning agent | 7.30 | 73.00 | 1% | 0.073 |
| | polysaccaride | | | | | |
| TegoRheo8510 | Polyurethane | Shear thinning agent | 2.50 | 25.00 | 60% | 1.500 |
| Disperbyk 190 | Blockcopolymer | Dispersant | 1.40 | 14.00 | 40% | 0.560 |
| Zetasperse 1600 | 2,4,7,9- | Wetting agent | 1.20 | 12.00 | 15% | 0.180 |
| | Tetramethyldec-5- | | | | | |
| | in-4,7-diol | | | | | |
| Poylethylenglycol | Poylethylenglycol | Moderator | 0.20 | 2.00 | 100% | 0.200 |
| | PEG 20000 | | | | | |
| 2-Phenoxyethanol | 2-Phenoxyethanol | Biocide | 0.16 | 1.60 | 0% | — |
| Thickener 1 | water-soluble | Shear thinning agent | 0.12 | 1.20 | 1% | 0.001 |
| | polysaccaride | | | | | |
| CsAlF₄ | Cesium tetra | Cesium flux | 1.60 | 16.00 | 100% | 1.600 |
| | fluoroaluminate | | | | | |
| KAlF₄ | Potassium tetra | Potassium flux | 36.00 | 360.00 | 100% | 36.000 |
| | fluoroaluminate | | | | | |
| | | | 100.00 | 1,000.00 | | 100.00 |

### Preparation and Testing of Example L

TABLE 13
Example L - Composition breakdown of micronized paste with associative thickener.

| Compound | Chemical name | ITEM | Part % | Quantity [kg] | solids % | abs w % |
|---|---|---|---|---|---|---|
| Water | | | 42.02 | 420.20 | | 56.127 |
| Disperbyk 184 | Block copolymer 2 | Polymeric dispersant | 4.00 | 40.00 | 52% | 2.080 |
| Alberdingk | Acrylat-Copolymer- | Binder | 3.50 | 35.00 | 40% | 1.400 |
| AC3600 | Dispersion | | | | | |
| Thickener 1 | water-soluble | Shear thinning agent | 7.30 | 73.00 | 1% | 0.073 |
| | polysaccaride | | | | | |
| TegoRheo8510 | Polyurethane | Shear thinning agent | 2.50 | 25.00 | 60% | 1.500 |
| Disperbyk 190 | Blockcopolymer | Dispersant | 1.40 | 14.00 | 40% | 0.560 |
| Zetasperse 1600 | 2,4,7,9- | Wetting agent | 1.20 | 12.00 | 15% | 0.180 |
| | Tetramethyldec-5- | | | | | |
| | in-4,7-diol | | | | | |
| Poylethylenglycol | Poylethylenglycol | Moderator | 0.20 | 2.00 | 100% | 0.200 |
| | PEG 20000 | | | | | |
| 2-Phenoxyethanol | 2-Phenoxyethanol | Biocide | 0.16 | 1.60 | 100% | 0.160 |
| Diutan Gum | water-soluble | Shear thinning agent | 0.12 | 1.20 | 100% | 0.120 |
| | polysaccaride | | | | | |
| CsAlF₄ | Cesium tetra | Cesium flux | 1.60 | 16.00 | 100% | 1.600 |
| | fluoroaluminate | | | | | |
| KAlF₄ | Potassium tetra | Potassium flux | 36.00 | 360.00 | 100% | 36.000 |
| | fluoroaluminate | | | | | |
| | | | 100.00 | 1.000.00 | | 100.00 |

### IV: Printing Performance of Jetflux Paste Formulations

TABLE 14
Viscosities of the semi-finished flux paste after thinning with water

| | | | | Viscosity |
|---|---|---|---|---|
| Component | Paste % | Water % | Solids % | [maps] |
| Jetflux 2805-50Cs | 100 | 0 | 48 | 11076 |
| Jetflux 2805-50Cs | 80 | 20 | 38.4 | 2750 |
| Jetflux 2805-50Cs | 40 | 60 | 19.2 | 21 |

TABLE 15
Shear recovery and stat. viscosity of
HEUR containing Jetflux formulations

| | Water | Heur | Shear | Viscosity | Printed |
|---|---|---|---|---|---|
| Example G, H, I | % | % | Rec. % | [maps] | Dots |
| Jetflux 2805-50Cs | 20 | 0.00 | 88% | 2750 | 180,302 |
| Jetflux 2805-50Cs | 20 | 2.50 | 99% | 4208 | 180,302 |
| (G) | | | | | |
| Jetflux 2805-50Cs | 20 | 5.00 | 101% | 6847 | 32,333 |
| (H) | | | | | |
| Jetflux 2805-50Cs | 20 | 7.50 | 94% | 8859 | 0 |
| (I) | | | | | |

TABLE 16
Summary of target ranges for Jetflux formulation

| Target ranges | | | | |
|---|---|---|---|---|
| for Jetflux | Low | Target | High | Importance |
| Viscosity of | 1-1000 | 2000-4000 | 4000-6000 | Printing |
| Jetflux [mPas] | | | | performance |
| Shear Recovery | 70-80% | 90-100% | 99-105% | Dot shape |
| Organic solids | 0-1 | 1-3 | 3-6 | Carbon black |
| [abs w %] | | | | on solder |
| Flux % | 30-35 | 35-40 | 40-48 | Parts integrity |
| Particle size | 1-5 | 5-10 | 1-20 | nozzle blocking |
| D95 [μm] | | | | |
| Acrylic binder | 0.1-0.4 | 0.4-0.8 | 1.2-2.8 | dot adhesion |

### V: Results of Testing of Examples A-L

The flux formulations according to the above formulations of examples A-L can be manufactured and filled in cartridges. Each of the formulations with an initial viscosity between 2000-4000 mPas and were found suitable for jet dispensing using a Nordson printing head. In this case, a long-term printing test on an area of 100×250 cm2 substrate was performed for each formulation, which ended after 180,000 points. Tables 16-18, as well las FIG. 4, report/illustrate the results of the testing.

Specifically, Table 17 reports the number of dots printed, viscosity (mPas) of the formulation, any observed blocking of the printer nozzle, as well as the resulting overall performance of the formations. Table 18 reports the static viscosity (mPas) of the formulation, the shear recovery %, the average dot weight, and overall performance of the printed formulations where FIG. 4 supplementally illustrates the findings of Table 18 including depictions of each of the dot structures. Table 19 reports the particle size distributions (each of the PD 5, PD 50, and PD 95) for each formulation as well as the resulting printing performance.

TABLE 17
Printing test results of Jetflux formulations (1 of 3)

| | Printed | | Nozzle | Viscosity | |
|---|---|---|---|---|---|
| Formulation | dots | Printing results | clogging | [mPas] | Conclusions |
| Example A | N/A | aborted, no printing | N/A | 21 | Viscosity too low |
| | | possible | | | |
| Example B | 180,302 | Max number of dots | nozzle | 11076 | High viscosity led |
| | | | clogging | | to nozzle clogging |
| Example C | 180,302 | Max number of dots | very minor | 3402 | Favorable range |
| | | | nozzle | | for viscosity |
| | | | clogging | | |
| Example D | 142,762 | Max number of dots | minor nozzle | 2077 | Printing ok, lower |
| | | not achieved 78% | clogging | | viscosity limit |
| | | | | | approached |
| Example E | 133,262 | Max number of dots | nozzle | 4117 | Printing OK, but |
| | | not achieved 73% | blockage | | high viscosity limit |
| | | | occurred | | |
| Example F | 180,302 | Max number of dots, | dripping and | 402 | viscosity too low, |
| | | but performance not | nozzle | | particle size high |
| | | OK | blockage | | |
| Example G | 180,302 | Max number of dots, | minor nozzle | 4208 | Printing OK, but |
| | | dot shape ok. | clogging | | high viscosity limit |
| Example H | 32,333 | Printing | strong nozzle | 6847 | Viscosity limit |
| | | performance low | clogging | | exceeded |
| Example I | N/A | no printing possible, | strong nozzle | 8859 | Viscosity limit |
| | | | clogging | | exceeded |
| Example J | 45,267 | poor printing results | strong nozzle | 7724 | Viscosity limit |
| | | | clogging | | exceeded |
| Example K | 90,533 | poor printing results | strong nozzle | 5548 | Viscosity limit |
| | | | clogging | | exceeded |
| Example L | 180,302 | best printing | very minor | 2736 | Favorable range |
| | | performance, | nozzle | | for viscosity |
| | | | clogging | | |

TABLE 18
Printing test results of Jetflux formulations (2 of 3)

| | | Shear | | | Result |
|---|---|---|---|---|---|
| | Static | recovery | Average | FIG. 4 | [0: Failed, 1: Poor, |
| | viscosity | of viscous | dotweight | Illustration | 2: Acceptable 3: Good; |
| Formulation | [mPas] | Paste [%] | [μg/dot] | Element | 4: Very Good] |
| Example A | 21 | 0% | — | 410 | 0 |
| Example B | 11076 | 83% | 71 | 411 | 1 |
| Example C | 3402 | 94% | 53 | 412 | 4 |
| Example D | 2077 | 92% | 56 | 413 | 4 |
| Example E | 4117 | 95% | 38 | 414 | 3 |
| Example F | 402 | 53% | 76 | 415 | 1 |
| Example G | 4208 | 99% | 57 | 416 | 3 |
| Example H | 6847 | 101% | — | 417 | 3 |
| Example I | 8859 | 94% | — | 418 | 0 |
| Example L | 2736 | 108% | 55 | 419 | 4 |

TABLE 19
Printing test results of Jetflux formulations (3 of 3)

| | No. | | | PSD | PSD | PSD | |
|---|---|---|---|---|---|---|---|
| | Printed | Printing | | D5 | D50 | D95 | |
| Formulation | dots | results | Particle size | [μm] | [μm] | [μm] | Conclusions |
| Example A | 0 | Aborted, | Particles small | 0.69 | 3.00 | 9.61 | |
| | | | enough to pass | | | | |
| | | | nozzle | | | | |
| Example B | 180,302 | Maximum | Particles small | 0.84 | 2.98 | 9.23 | |
| | | dots | enough to pass | | | | |
| | | reached | nozzle | | | | |
| Example C | 180,302 | Maximum | Particles small | 0.76 | 2.96 | 9.24 | |
| | | dots | enough to pass | | | | |
| | | reached | nozzle | | | | |
| Example D | 142,762 | Acceptable | Particles small | 0.75 | 2.97 | 9.27 | |
| | | printing, | enough to pass | | | | |
| | | but less | nozzle | | | | |
| | | than | | | | | |
| | | maximum | | | | | |
| Example E | 133,262 | Acceptable | Buildup of debris | 0.38 | 3.13 | 11.55 | agglomerates |
| | | printing, | inside the nozzle | | | | expected |
| | | but less | | | | | |
| | | than | | | | | |
| | | maximum | | | | | |
| Example F | 180,302 | Maximum | Agglomerates caused | 14.95 | 92.69 | 237.16 | nozzle |
| | | dots | nozzle blockage | | | | blockage |
| | | reached | | | | | occurred |
| Example G | 180,302 | Maximum | particles small | 0.64 | 2.89 | 9.16 | |
| | | dots | enough to pass | | | | |
| | | reached | nozzle | | | | |
| Example H | 32,333 | Poor | particles small | 0.70 | 3.10 | 10.04 | agglomerates |
| | | printing | enough to pass | | | | expected |
| | | performance | nozzle | | | | |
| Example I | | Aborted | particles small | 0.67 | 3.04 | 9.54 | Viscosity too |
| | | | enough to pass | | | | high |
| | | | nozzle | | | | |
| Example J | 45,267 | Poor | particles small | 0.71 | 2.95 | 9.01 | Viscosity too |
| | | printing | enough to pass | | | | high |
| | | performance | nozzle | | | | |
| Example K | 90,533 | Poor | Agglomerates caused | 0.35 | 3.11 | 12.36 | agglomerates |
| | | printing | nozzle blockage | | | | expected |
| | | performance | | | | | |
| Example L | 180,302 | Maximum | particles small | 0.64 | 2.93 | 9.40 | |
| | | dots | enough to pass | | | | |
| | | reached | nozzle | | | | |

As demonstrated in Table 17, formulations with viscosities above 4000 mPas led to clogging of the nozzle of the printhead which prohibited the material from being completely discharged through the nozzle during printing. For example, each of the formulations of examples B, H, I, J, and K exhibited at least some clogging behavior. Formulations with viscosities below 2000 mPas resulted in the formation of spray mist and spatter, for example, the formulations of examples D and F. In each case, the residue that forms at the outlet of the printing nozzle provides information about whether the paste is too thin (e.g., too low a viscosity; e.g., below 2000 mPas) or too thick (too high a viscosity; e.g., above 4000 mPas). For example, if the paste is too thick (i.e., too high a viscosity), a paste thread can be observed that begins to grow at the nozzle, indicating blockage of the nozzle. If the past is too thin (e.g., the viscosity is too low), a fine deposit is formed on the substrate due to the resulting spray mist of the low viscosity formulation. The printing process is aborted if 1) the nozzle becomes blocked, 2) the paste residue dries up, and/or 3) if agglomerates become stuck in the nozzle.

As demonstrated in Table 18 and illustrated in FIG. 4, high printing speed and printing quality was observed in the formulations of Examples C, D, G, and L. In these cases, the quantity of flux per dot was controlled by the firing frequency under printing conditions. The shear recovery of these formulations was found above 90%, which led to symmetric and separated dots. Conversely, formulations B and F showed points that overlap and appear as a solid line. This occurred due to the low resilience of the paste where, when the drop of Jetflux hits the surface of the substrate, the drops burst and lead to the dots of Jetflux running into one another. If the viscosity is too high and the recovery force is low, elongated droplets that overlap form. All viscosities are measured with a Thermo Scientific Instruments Visco-tester. Measurements are made at 22° C.; FL100, 11.5/s.

As demonstrated in Table 19, with some formulations, misfires and blocking of the nozzle occurred with increasing printing time. This may suggest that agglomerates had formed in the micronized paste, which led to the nozzle becoming clogged. In example F, these agglomerates could be reliably detected using laser particle measurement. The cause was a dispersing additive which, in higher concentrations, crosslinks the particles instead of keeping them at a distance. This additive is also contained in formulations E, J, and K, where its presence only led to very rare print failures. High printing speed and printing quality was observed in the examples C, D, G and L; these formulations contain well dispersed flux particles and 95% of the particles in solution were below 10 μm.

The flux formulations of Examples A-L were tested for brazing performance characteristics, where each formulation performed well in brazing experiments, as presented in Table 20.

TABLE 20
Brazing performance of Jetflux Formulations

| | Printed | Brazing angle | Formation of | |
|---|---|---|---|---|
| Example | dots | coupon test | soldered seam | Charring |
| Example A | 0 | not tested | not tested | not tested |
| Example B | 180,302 | high strength | uneven, wide | no deposits |
| | | | spread | |
| Example C | 180,302 | high strength | very even | no deposits |
| Example D | 142,762 | high strength | very even | carbon deposits |
| | | | | along the brazed seam |
| Example E | 133,262 | high strength | uneven, wide | carbon deposits |
| | | | spread | along the brazed seam |
| Example F | 180,302 | high strength | not tested | not tested |
| Example G | 180,302 | high strength | uneven | carbon deposits |
| | | | | along the brazed seam |
| Example H | 32,333 | high strength | even, wide | carbon deposits |
| | | | spread | along the brazed seam |
| Example I | 0 | high strength | even | carbon deposits |
| | | | | along the brazed seam |
| Example J | 45,267 | high strength | even | carbon deposits |
| | | | | along the brazed seam |
| Example K | 90,533 | high strength | even | less residue formation |
| Example L | 180,302 | high strength | very even, | no deposits |

As demonstrated in Table 20, the formulations B, C and L provide a higher brazed seam quality, because less carbon deposits appeared on the solder seam, where the solidified solder was very even and smooth, and the gap between the connected parts were sufficiently filled to provide a high joint strength.

Table 21 illustrates the overall performance of the Jetflux formulations as a compilation of all of the previously described tests performed in relation to each of Tables 17-20, which results in the determination of the highest-performing formulation. However, although one formulation may have exhibited the highest tested performance, it is noted that differing conditions and/or variations in testing may yield different results. Therefore, the determined highest performing formulation should net be considered the only formulation that exhibits high performance, nor imply that other Jetflux formation are disadvantageous.

TABLE 21
Overall performance of Jetflux Formulations:

| | Printing | | | | | | Particle Size | | Brazing | | | | |
|---|---|---|---|---|---|---|---|---|---|---|---|---|---|
| | | | Nozzle | Dot | Dot | | Stat. | | Brazing | Solder | | | |
| | Printed | Printing | Clog | shape | shape | total | viscosity | PSD | angle | seam | | total | Final |
| Formulation | dots | Rating | Rating | (hor) | (ver) | score | [mPas] | [μm] | strength | integrity | charring | score | Score |
| Example A | 0 | 0 | 0 | 0 | 0 | 0 | 21 | 9.61 | 3 | 3 | 3 | 9 | 9 |
| Example B | 180,302 | 4 | 1 | 1 | 2 | 8 | 11,076 | 9.23 | 3 | 3 | 3 | 9 | 17 |
| Example C | 180,302 | 4 | 3 | 4 | 4 | 15 | 3,402 | 9.24 | 3 | 3 | 3 | 9 | 24 |
| Example D | 142,762 | 3 | 3 | 4 | 4 | 14 | 2,077 | 9.27 | 3 | 2 | 2 | 7 | 21 |
| Example E | 133,262 | 3 | 1 | 3 | 2 | 9 | 4,117 | 11.55 | 3 | 3 | 1 | 7 | 16 |
| Example F | 180,302 | 4 | 0 | 1 | 1 | 6 | 402 | 237.16 | 3 | 1 | 1 | 5 | 11 |
| Example G | 180,302 | 4 | 3 | 3 | 4 | 14 | 4,208 | 9.16 | 3 | 3 | 1 | 7 | 21 |
| Example H | 32,333 | 1 | 1 | 3 | 1 | 6 | 6,847 | 10.04 | 3 | 3 | 1 | 7 | 13 |
| Example I | — | 0 | 0 | 0 | 0 | 0 | 8,859 | 9.54 | 3 | 2 | 1 | 6 | 6 |
| Example J | 45,267 | 1 | 1 | 1 | 1 | 4 | 7,724 | 9.01 | 3 | 3 | 1 | 7 | 11 |
| Example K | 90,533 | 3 | 1 | 1 | 1 | 6 | 5,548 | 12.36 | 3 | 3 | 2 | 8 | 14 |
| Example L | 180,302 | 4 | 4 | 4 | 4 | 16 | 2,736 | 9.4 | 3 | 3 | 3 | 9 | 25 |

The individual results are evaluated with grades between 0 and 4 for each category, with the best result, a ranking is formed in which particularly good printing results are achieved with the formulations C, D, G and L and whose viscosity is between 2000 and 4200 mPas.

### VI: Application Examples

### Example M

In this Example, the blended flux formulation of any one of Examples A-L is printed on aluminum sheets and brazed to achieve heat exchanger parts. The heat exchanger parts are suitable for the construction of car bodies, battery packs, fuel cells of electric vehicles or hydrogen vehicles (HV).

### Example N

In this Example, the blended flux formulation of any one of Examples A-L is printed on aluminum sheets and brazed to achieve heat exchanger parts. The heat exchanger parts are suitable for the construction of automotive or transport climate control systems such as condensers, gas coolers, evaporators and heaters.

### Example O

In this Example, the blended flux formulation of any one of Examples A-L is printed on aluminum sheets and brazed to achieve heat exchanger parts. The heat exchanger parts are suitable for automotive engines or powertrains as radiators, oil coolers, fuel coolers, exhaust gas recirculation systems (EGR), or charge air coolers.

### Example P

In this Example, the blended flux formulation of any one of Examples A-L is printed on aluminum sheets and brazed to achieve heat exchanger parts. The heat exchanger parts are suitable for cooling photovoltaic elements or solar heat collectors.

### Example Q

In this Example, the blended flux formulation of any one of Examples A-L is printed on aluminum sheets and brazed to achieve heat exchanger parts. The heat exchanger parts are suitable for components in residential air conditioning systems such as condensers, evaporators, reversible, or radiators.

### Example R

In this Example, the blended flux formulation of any one of Examples A-L is printed on aluminum sheets and brazed to achieve heat exchanger parts. The heat exchanger parts are suitable for refrigeration in industrial, domestic, commercial, and transport applications such as condensers or evaporators for refrigerants or cooling fluids.

### Aspects

Aspect 1 is a flux paste composition comprising: one or more fluoroaluminate based flux agents; one or more thickening agents; a carrier; a dispersant; a wetting agent; a defoamer; a moderator; and a biocide agent.

Aspect 2 is the flux paste composition of Aspect 1, wherein the one or more fluoroaluminate based flux agents comprise both a KAlF4 flux agent and an AlCsF4 flux agent.

Aspect 3 is the flux paste composition of Aspect 2, wherein the KAlF4 is present at a ratio of 19:3 to the AlCsF4.

Aspect 4 is the flux paste composition of any one of Aspects 1 to 3, wherein the one or more fluoroaluminate based flux agents comprises 40% or more of the flux paste composition.

Aspect 5 is the flux paste composition of any one of Aspects 1 to 4, wherein the one or more thickening agents comprise any one of a cellulose ether based thickener, a polysaccharide based thickener, and/or acrylate based thickener.

Aspect 6 is the flux paste formulation of any one of Aspects 1 to 5, wherein the one or more thickening agents is the polysaccharide thickener diutan gum, the gum comprising 1% or less of the flux paste composition.

Aspect 7 is the flux paste formulation of any one of Aspects 1 to 6, wherein the carrier comprises water in an amount of 45% or more, based on the total weight of the flux paste composition.

Aspect 8 is the flux paste formulation of any one of Aspects 1 to 7, wherein at least one of the following conditions is present:
(i) the dispersant comprises a polymeric dispersant Disperbyk 190, the Disperbyk 190 comprising 2% or less of the flux paste composition,
(ii) the wetting agent comprises a ZetaSperse® 1600, the ZetaSperse® 1600 comprising 2% or less of the flux paste composition,
(iii) the defoamer comprises a Surfynol 104, the Surfynol 104 comprising 1% or less of the flux paste composition.

Aspect 9 is the flux paste formulation of any one of Aspects 1 to 8, wherein the moderator comprises any one of poylethylenglycol PEG 400, poylethylenglycol PEG 1000, poylethylenglycol PEG 10000, Poylethylenglycol PEG 2000, polypropylene glycol PPG 400, and/or polypropylene glycol PPG 2000, the moderator comprising 1% or less of the flux paste composition.

Aspect 10 is the flux paste formulation of any one of Aspects 1 to 9, wherein the biocide comprises a 2-Phenoxyethanol, the 2-Phenoxyethanol comprising 1% or less of the flux paste composition.

Aspect 11 is a blended flux composition comprising: a micronized flux paste including one or more fluoroaluminate flux agents; and one or more rheological additives, the rheological additives selected based upon printing the blended flux composition by a contactless inkjet printing system.

Aspect 12 is the blended flux composition of Aspect 11, wherein at least one of the following conditions is present:
(i) the one or more rheological additives comprises a polysaccharide-based shear thinning agent, the polysaccharide based shear thinning agent comprising between 5 and 10 wt. % of the blended flux composition,
(ii) the one or more rheological additives comprises an acrylate based binding agent, the acrylate based binding agent comprising from 3 wt. % to 12 wt. % of the blended flux composition,
(iii) the one or more rheological additives comprises a polyurethane based thickening agent, the polyurethane based thickening agent comprising from 2 wt. % to 5 wt. % of the blended flux composition,
(iv) the one or more rheological additives comprises a polymeric dispersant, the polymeric dispersant comprising from 2 wt. % to 5 wt. % of the flux paste composition.

Aspect 13 is the blended flux composition of Aspect 11 or Aspect 12, further comprising an aqueous carrier, the aqueous carrier comprising from 5 wt. % to 70 wt. % of the flux paste composition.

Aspect 14 is a method of printing a flux formulation comprising: inkjet printing a blended flux formulation prepared from a micronized flux concentrate comprising: one or more fluoroaluminate flux agents, one or more thickening agents, a carrier, a dispersant, a wetting agent, a defoamer, a moderator, and a biocide agent.

Aspect 15 is the method of Aspect 14, wherein the micronized flux concentrate has an average particle size diameter of from 100 μm to 1 μm, as determined by laser diffraction based on Mie scattering.

Aspect 16 is the method of Aspect 14 or Aspect 15, wherein the micronization of the flux concentrate is performed by a jet milling process.

Aspect 17 is the method of any one of Aspects 14 to 16, wherein the micronized flux concentrate is milled to a particle size of from about 1 μm to 30 μm.

Aspect 18 is the method of any one of Aspects 14 to 17, wherein the viscosity of the micronized flux paste is from about 500 mPas to 12,000 mPas.

Aspect 19 is the method of any one of Aspects 14 to 18, wherein the viscosity of the blended flux formulation is from about 1,000 mPas to 4,8,000 mPas.

Aspect 20 is the method of any one of Aspects 14 to 19, wherein the inkjet printing is performed according to at least one of the following techniques:
(i) contactlessly,
(ii) a drop on demand inkjet process,
(iii) by a print nozzle with a diameter of from 0.3 mm to 1.2 mm,
(iv) at a droplet printing frequency of 250 Hz or more.

Aspect 21 is the method of any one of Aspects 14 to 20, wherein the blended flux formulation is inkjet printed at a speed of above 150 m/min.

Aspect 22 is the method of any one of Aspects 14 to 21, wherein the blended flux formulation is printed on aluminum sheets and brazed to achieve heat exchanger parts or parts that allows construction of the car body, battery packs, fuel cells of electric EVs or hydrogen vehicles (HV).

Aspect 23 is the method of any one of Aspects 14 to 22, wherein the blended flux formulation is printed on aluminium sheets and brazed to achieve heat exchanger parts or parts that are used in automotive or transport climate control systems as condensers, gas coolers, evaporators or heaters.

Aspect 24 is the method of any one of Aspects 14 to 23, wherein the blended flux formulation is printed on aluminium sheets and brazed to achieve heat exchanger parts or parts that are used in automotive engine or powertrains as radiators, oil coolers, fuel coolers, exhaust gas recirculation systems (EGR) or charge air coolers (CAC).

Aspect 25 is the method of any one of Aspects 14 to 24, wherein the blended flux formulation is printed on aluminium sheets and brazed to achieve heat exchanger parts and parts that are used to cool photovoltaic elements or solar heat collectors.

Aspect 26 is the method of any one of Aspects 14 to 25, wherein the blended flux formulation is printed on aluminium sheets and brazed to achieve heat exchanger parts that are used in residential air conditioning as condensers, evaporators, reversible or radiators.

Aspect 27 is the method of any one of Aspects 14 to 26, wherein the blended flux formulation is printed on aluminium sheets and brazed to achieve heat exchanger parts that are used in refrigeration and cooling in industrial, domestic, commercial and transportation area as condensers or evaporators for refrigerants or cooling fluids.

1. A flux paste composition comprising:
one or more fluoroaluminate based flux agents;
one or more thickening agents;
a carrier;
a dispersant;
a wetting agent;
a defoamer;
a moderator; and
a biocide agent.

2. The flux paste composition of claim 1, wherein the one or more fluoroaluminate based flux agents comprise both a KAlF₄ flux agent and an AlCsF₄flux agent.

3. The flux paste composition of claim 2, wherein the KAlF₄ is present at a ratio of 19:3 to the AlCsF₄.

4. The flux paste composition of claim 1, wherein the one or more fluoroaluminate based flux agents comprises 40% or more of the flux paste composition.

5. The flux paste composition of claim 1, wherein the one or more thickening agents is selected from the group consisting of cellulose ether based thickeners, polysaccharide based thickeners, and acrylate based thickeners.

6. The flux paste composition of claim 5, wherein the one or more thickening agents is a polysaccharide thickener diutan gum, the gum comprising 1% or less of the flux paste composition.

7. The flux paste composition of claim 1, wherein the carrier comprises water in an amount of 45% or more, based on the total weight of the flux paste composition.

8. The flux paste composition of claim 1, wherein at least one of the following conditions is present:
(i) the dispersant comprises a polymeric dispersant Disperbyk 190, the Disperbyk 190 comprising 2% or less of the flux paste composition,
(ii) the wetting agent comprises a ZetaSperse® 1600, the ZetaSperse® 1600 comprising 2% or less of the flux paste composition,
(iii) the defoamer comprises a Surfynol 104, the Surfynol 104 comprising 1% or less of the flux paste composition.

9. The flux paste composition of claim 1, wherein the moderator is selected from the group consisting of poylethylenglycol PEG 400, poylethylenglycol PEG 1000, poylethylenglycol PEG 10000, Poylethylenglycol PEG 2000, polypropylene glycol PPG 400, and polypropylene glycol PPG 2000, the moderator comprising 1% or less of the flux paste composition.

10. The flux paste composition of claim 1, wherein the biocide comprises a 2-Phenoxyethanol, the 2-Phenoxyethanol comprising 1% or less of the flux paste composition.

11. A blended flux composition comprising:
a micronized flux paste including one or more fluoroaluminate flux agents; and
one or more rheological additives, the rheological additives selected based upon printing the blended flux composition by a contactless inkjet printing system.

12. The blended flux composition of claim 11, wherein at least one of the following conditions is present:
(i) the one or more rheological additives comprises a polysaccharide-based shear thinning agent, the polysaccharide based shear thinning agent comprising between 5 and 10 wt. % of the blended flux composition,
(ii) the one or more rheological additives comprises an acrylate based binding agent, the acrylate based binding agent comprising from 3 wt. % to 12 wt. % of the blended flux composition,
(iii) the one or more rheological additives comprises a polyurethane based thickening agent, the polyurethane based thickening agent comprising from 2 wt. % to 5 wt. % of the blended flux composition,
(iv) the one or more rheological additives comprises a polymeric dispersant, the polymeric dispersant comprising from 2 wt. % to 5 wt. % of the flux paste composition.

13. The blended flux composition of claim 11, further comprising an aqueous carrier, the aqueous carrier comprising from 5 wt. % to 70 wt. % of the flux paste composition.

14. A method of printing a flux composition comprising:
inkjet printing a blended flux formulation prepared from a micronized flux concentrate comprising:
one or more fluoroaluminate flux agents,
one or more thickening agents,
a carrier,
a dispersant,
a wetting agent,
a defoamer,
a moderator, and
a biocide agent.

15. The method of claim 14, wherein the micronized flux concentrate has an average particle size diameter of from 100 μm to 1 μm, as determined by laser diffraction based on Mie scattering.

16. The method of claim 14, wherein the flux concentrate is micronized by a jet milling process and has at least one of the following properties:
(i) a particle size range from about 1 μm to 30 μm,
(ii) a viscosity of from about 500 mPas to 12,000 mPas,

17. The method of claim 14, wherein the viscosity of the blended flux formulation is from about 1,000 mPas to 4,8,000 mPas.

18. The method of claim 14, wherein the inkjet printing is performed according to at least one of the following techniques:
(i) contactlessly,
(ii) a drop on demand inkjet process,
(iii) by a print nozzle with a diameter of from 0.3 mm to 1.2 mm,
(iv) at a droplet printing frequency of 250 Hz or more,

19. The method of claim 14, wherein the blended flux formulation is inkjet printed at a speed of above 150 m/min.

20. The method of claim 14, wherein the blended flux formulation is printed on aluminum sheets and brazed to achieve a mechanical part selected from the group consisting of car bodies, battery packs, fuel cells, condensers, gas coolers, evaporators, heaters, radiators, oil coolers, fuel coolers, exhaust gas recirculation systems, charge air coolers, heat exchangers for photovoltaic elements, heat exchangers for solar heat collectors, and evaporators.
